(19) United States
(12) Patent Application Publication
(10) Pub. No.: US 2004/0051320 A1
(43) Pub. Date: Mar. 18, 2004

(54) Multifunctional clutch actuating device

(76) Inventor: Christoph Woernle, Rostock (DE)

Correspondence Address: Striker Striker & Stenby, 103 East Neck Road, Huntington, NY, 11743, US

(21) Appl. No.: 10/466,218

(22) PCT Filed: Dec. 21, 2001
(86) PCT No.: PCT/DE01/04852

(30) Foreign Application Priority Data
Feb. 22, 2001 (DE) 101 08 477.3

(51) Int. Cl. F02N 11/04

(52) U.S. Cl. 290/47; 123/179.28

(57) ABSTRACT

The invention discloses an actuator (1) that can be used as a clutch actuator/starter, as a clutch actuator/generator, or as a clutch actuator/starter/generator. Consequently, an actuator that is embodied as an auxiliary unit can perform several functions for the motor (12), thus permitting the number of parts, the amount of space required, and the weight of the motor to be reduced.

### PRIOR ART

The current invention relates to an actuator for actuating clutches according to the preamble to claim 1.

In vehicles with manual transmissions, the transmission of force from the motor to the gear train occurs, for example, by means of a controllable friction clutch. This friction clutch makes it possible to interrupt the positive connection during a gear shift. In friction clutches, as a rule two disks are pressed together in order to permit a torque to be transmitted by means of the frictional contact. The torque is controlled, for example, by means of the contact force of the clutch disks. The clutch can be actuated mechanically, hydraulically, or electrohydraulically. In addition, automated manual transmissions are also known, which are actuated electrohydraulically, for example.

For example, DE 197 29 997 has disclosed an actuating device for a friction clutch, which compensates for the wear that occurs in friction clutches, without requiring additional space. In this instance, the adjusting device has a separate drive unit, which can be brought into operational connection with the friction clutch by means of a drive mechanism. The drive mechanism must be provided with a compensation device in order to compensate for a wear-induced position change of the compression spring of the friction clutch.

DE 41 33 962 has disclosed an adjusting drive in the form of a planetary gear train, with an electric direct current motor disposed axially parallel to it. The shaft of the d.c. motor is connected directly to a driving gear embodied in the form of a planet gear. The planetary gear train is composed of two planes and in the first plane is connected by means of the driving gear to a gear train that functions in a manner similar to a planetary gear train since the driving gear is stationary and the ring gear and the sun gear are driven in opposite rotation directions. In the second plane of the planetary gear train, differences in tooth counts in the ring gear and the sun gear in relation to the corresponding tooth counts of the first plane, produce a correspondingly transformed speed in the planet gear support. In this connection, it is also possible to design the planetary gear train with a helical drive in order to execute small translational movements.

In addition to a clutch actuator, a motor also requires a starter for starting the motor, and a generator for charging the battery. Normally, the clutch actuator, the starter, and the generator are each separate auxiliary units of the vehicle drive train.

### ADVANTAGES OF THE INVENTION

The actuator for actuating a clutch according to the invention has the advantage over the prior art that the actuator can simultaneously be used as a starter for starting a motor. In other words, the invention proposes an auxiliary unit that simultaneously serves as a clutch actuator and as a starter. As a result, the motor can be more compact design and the number of auxiliary units can be reduced.

According to a preferred modification of the current invention, the device that is comprised of a combined clutch actuator and starter can also be used as a generator for charging the battery. This reduces the number of parts or auxiliary units even further, thus allowing the motor to be embodied in a simpler, more compact form. This achieves considerable cost advantages with regard to both manufacture and assembly since fewer parts have to manufactured and assembled. Moreover, this reduces the space required for the motor and in particular, also reduces the weight of the motor.

According to another preferred embodiment of the current invention, the actuator according to the invention can be used both as a clutch actuator and as a generator. This produces an auxiliary unit, which simultaneously has the functions as a clutch actuator and a generator for charging a battery. This also achieves the advantages mentioned above with regard to manufacturing costs, assembly costs, reduced space, and reduced weight.

According to a preferred exemplary embodiment of the current invention, a bypass clutch for bypassing the clutch is provided, thus particularly simplifying the starting process of the motor since the starter does not have to move any parts of the clutch while starting the motor.

According to another preferred embodiment of the current invention, a gear train, which the clutch actuator uses to bring the clutch into and out of engagement, preferably has a region with a helical gearing, which can serve to convert a rotational movement generated by the clutch actuator into a translational movement in order to bring the clutch into and out of engagement.

According to another advantageous embodiment of the current invention, the actuator is designed so as to permit the recovery of braking energy.

Preferably, the actuator according to the invention produces a synchronization of the controllable clutches during gear changes. In this case, the actuator facilitates the synchronization of a clutch during a gear-shifting maneuver. For example, the actuator here can function as a motor, which when the clutch is disengaged, accelerates a countershaft to a required synchronous speed.

Preferably, when the actuator is used as a starter, the combined actuator/starter brings the motor of the vehicle into engagement with an outer disk support by means of a gear train and an inner disk support, wherein the outer disk support is connected to the motor of the vehicle by means of a hollow shaft and a transmission, and the motor can thus be started.

According to another advantageous exemplary embodiment, when being used as a starter, the actuator starts the motor by means of a gear train, an inner disk support, and a shaft.

According to a preferred embodiment of the current invention, the rotary motion of a gear of the gear train is converted into an axial motion of the inner disk support by means of a thrust collar. This lends axial mobility to the thrust collar and the gear train axially shifts the thrust collar, thus allowing the thrust collar to bring the clutch into and out of engagement.

It is advantageous to use the actuator according to the invention in a double-clutch gear train. It is thus possible, both when the vehicle is stationary and when it is driving, to easily achieve the functions according to the invention of a clutch actuator, a starter for the motor, and a generator for the battery.

The invention consequently proposes a combined auxiliary unit that can be used as a clutch actuator/starter, a clutch actuator/generator, or as a clutch actuator/starter/generator. As a result, a number of functions of the vehicle are executed by only a single auxiliary unit, thus reducing the number of parts and in particular, reducing manufacturing and assembly costs. Furthermore, a single unit only takes up a small amount of space by contrast with a number of units, and the weight of the motor can be further reduced.

### DRAWINGS

A number of exemplary embodiments of the invention will be explained in detail in the description below in conjunction with the accompanying drawings.

FIG. 1 shows a schematic sectional depiction of an actuator according to the invention, according to a first exemplary embodiment of the current invention,

FIG. 2 shows a schematic sectional depiction of an actuator according to the invention, according to a second exemplary embodiment of the current invention, and

FIG. 3 shows a schematic sectional depiction of an actuator according to the invention, according to a third exemplary embodiment of the current invention.

### DESCRIPTION OF THE EXEMPLARY EMBODIMENTS

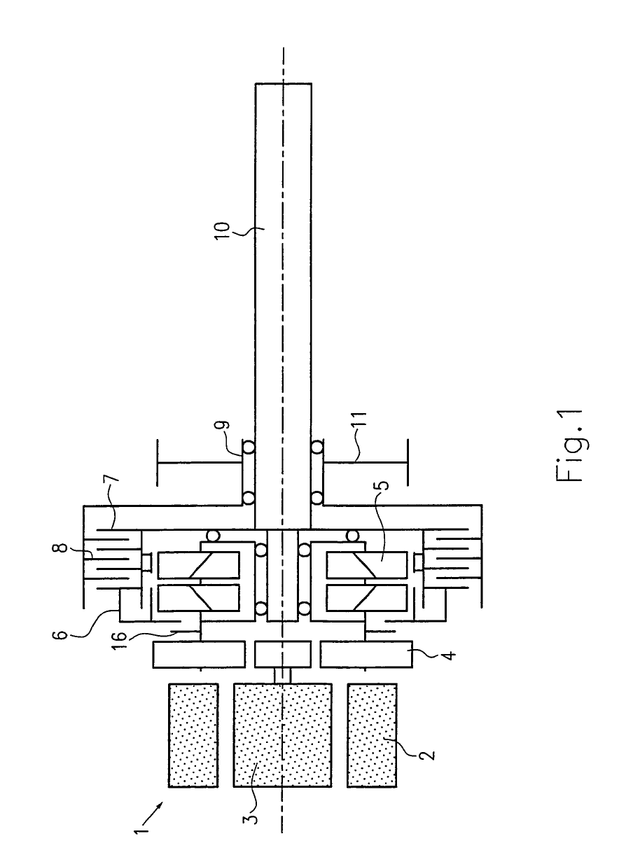

FIG. 1 shows a clutch according to a first exemplary embodiment of the current invention. In this instance, it is a wet-running disk clutch with an inner disk support 7 and an outer disk support 8. It serves to connect a hollow shaft 9, which communicates with a motor (not shown) by means of a transmission 11, to a shaft 10, which communicates with a gear train (not shown).

As also shown in FIG. 1, an actuator 1 is comprised of a stator 2 and a rotor 3. The rotor 3 is connected via a gear train 4 to a double planet gear 5, which is supported in rotary fashion on the shaft 10. The double planet gear 5 is connected to the inner disk support 7 by means of a thrust collar 6. This causes the rotational movement of the double planet gear 5 to be converted into a translational movement of the thrust collar 6 so that the thrust collar 6 brings the disk supports 7 and 8 into and out of engagement. This generates the axial motion of the thrust collar 6 by means of a rotational movement of the rotor 3 of the actuator 1 in relation to the rotation movement of the shaft 10. If the shaft 10 and the rotor 3 are rotating at the same speed, then the state of the clutch is not changed. If the rotor 3 is rotating in relation to the shaft 10, then the sign of the difference between the speed of the shaft 10 and the speed of the rotor 3 remains unchanged, whether the clutch is engaged or disengaged.

When the clutch is engaged, the two shafts 10 and 9 and the rotor 3 are interlocked. When the clutch is disengaged, the actuator gear train is locked together by the stopping of the thrust collar 6 against an opposing surface 16. As a result, the rotor 3 is interlocked with the shaft 10 by means of the gear train 4, the opposing surface 16, the thrust collar 6, and the inner disk support 7.

Consequently, both when the clutch is engaged and when it is disengaged, the rotor 3 is interlocked with the shaft 10 so that the actuator 1 can function as a clutch actuator, a starter, and a generator. The clutching operation is achieved by braking or driving the rotor 3 so that the rotor 3 has a speed that differs from that of the shaft 10.

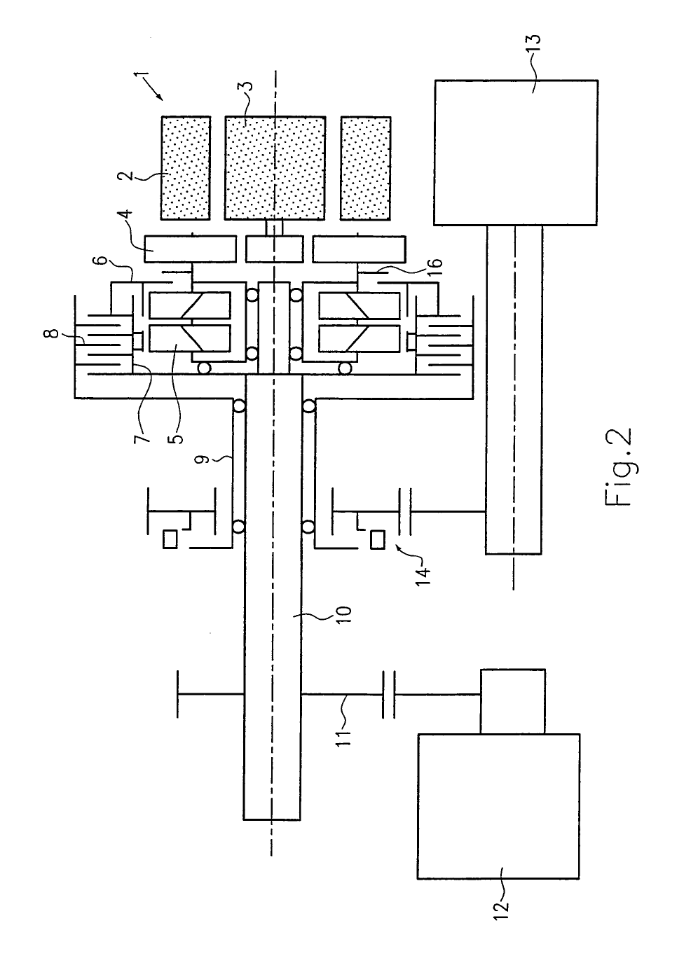

FIG. 2 shows an actuator according to the invention, according to a second exemplary embodiment of the current invention. Parts that are the same or functionally equivalent are labeled with the same reference numerals as in the first exemplary embodiment.

As shown in FIG. 2, the actuator 1 according to the second exemplary embodiment includes a stator 2 and a rotor 3. The rotor 3 is connected to a thrust collar 6 by means of a gear train 4 and a double planet gear 5. This thrust collar 6 moves an inner disk support 7 in the axial direction so that it engages or disengages from an outer disk support 8. The outer disk support 8 is in turn connected to a hollow shaft 9, which is supported on a shaft 10, which is connected to the inner disk support 7. A transmission 11 connects the shaft 10 to a motor 12. The hollow shaft 9 is connected to the vehicle 13 by means of a gear train 14. For the sake of simplicity, only one gear of this gear train 14 is shown in the drawing.

If the motor 12 is then to be started, the rotor 3 of the actuator 1 starts the motor 12 by means of the gear train 4, the double planet gear 5, the thrust collar 6, and the inner disk support 7. The stationary vehicle is thus disconnected because of the disengaged clutch 14. During the starting process, depending on the orientation of the gearing of the double planet gear 5, notice should be taken as to whether the clutch 7, 8 is engaged or disengaged since, depending on the type of gearing of the double planet gear 5, the thrust collar 6 presses the inner disk support 7 against the outer disk support 8 (variant A of the second exemplary embodiment) or the thrust collar 6 comes into contact with an opposing surface 16 so that the clutch is disengaged (variant B of the second exemplary embodiment). In the first instance, the outer disk support 8 and the hollow shaft 9 are then driven while the motor is being started; in the second instance, the rotor 3 only has to drive the gear train 4, 5, the thrust collar 6, the inner disk support 7, and the shaft 10.

When the vehicle is stationary, the actuator 1 is used as a generator, since the internal combustion engine is driving the rotor 3 via the shaft 10, the inner disk support 7, and the gear train 4. In order to be able to use the actuator 1 as a generator even while the vehicle is driving, the gearing of the double planet gear 5 must be embodied according to variant B of the second exemplary embodiment so that the clutch engages when the actuator 1 is being braked. Variant A of the second exemplary embodiment requires a double-clutch gear train in which there are two load paths so that the generator function can be produced using the respective load path that is not under load, while the other load path transmits the torque of the motor.

In this exemplary embodiment, a braking energy recovery is only possible—at least in part—if the gearing of the double planet gear 5 according to variant B of the second exemplary embodiment is oriented so that the clutch engages when the actuator 1 is being braked. Otherwise, it is not possible to recover braking energy.

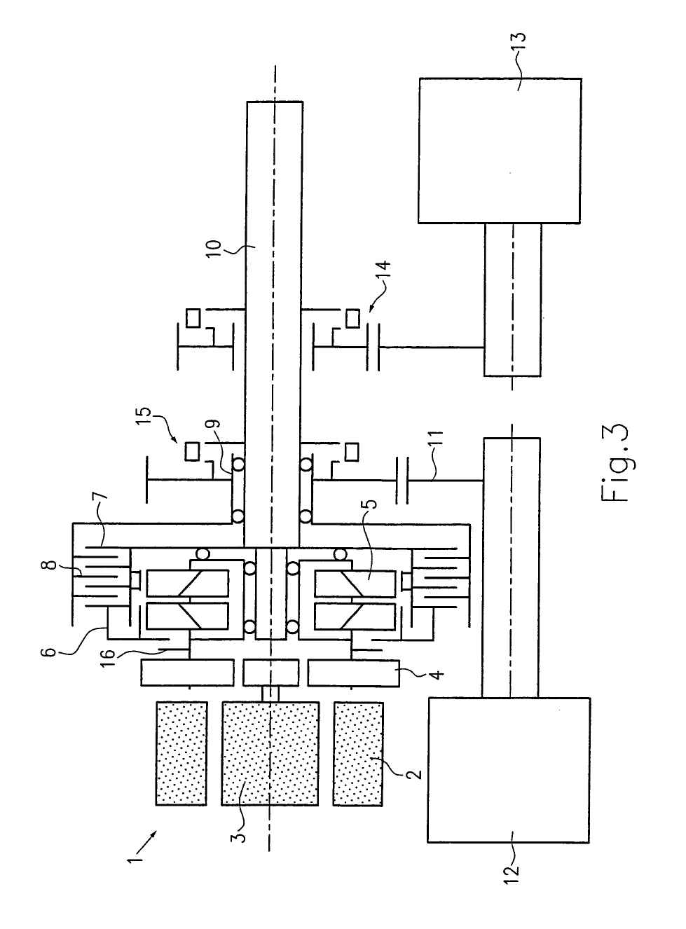

FIG. 3 shows a third exemplary embodiment of an actuator according to the invention. Parts that are the same or functionally equivalent are labeled with the same reference numerals as in the exemplary embodiments described above.

As shown in FIG. 3, the actuator 1 includes a stator 2 and a rotor 3. As in the exemplary embodiments described above, the rotor 3 is connected to an inner disk support 7 by means of a gear train 4, a double planet gear 5, and a thrust collar 6. The inner disk support 7 is in turn connected to a shaft 10. A motor 12 of the vehicle is connected by means of a transmission 11 to a hollow shaft 9, which is supported on the shaft 10. The hollow shaft 9 is in turn connected to the outer disk support 8. In addition, a bypass clutch 15 is provided between the hollow shaft 9 and the shaft 10 in order to bypass the clutch 7, 8. The vehicle 13 is connected to the drive train by means of a gear train 14, which is driven by the shaft 10. For the sake of a simpler depiction, FIG. 3 only shows one stage of the gear train 14.

According to the third exemplary embodiment, the actuator 1 according to the invention functions as follows: In order to start the motor 12, the double planet gear 5 is moved by means of the rotor 3 and the gear train 4. Depending on the direction of the helical gearing of the double planet gear 5, the thrust collar 6 is moved in the axial direction toward the actuator 1 or away from the actuator 1 so that the inner disk support 7 is brought into contact with the outer disk support 8 (variant A of the third exemplary embodiment) or is moved away from it (variant B of the third exemplary embodiment). In variant A of the third exemplary embodiment, the motor is started by means of the outer disk support 8, the hollow shaft 9, and the transmission 11. In variant B of the third exemplary embodiment, if—as a result of the helical gearing of the double planet gear 5 being inclined in the other direction—the inner disk support 7 is moved away from the outer disk support 8 until the thrust collar 6 comes into contact with an opposing surface 16, then the motor 12 can be started in such a way that a rotation of the rotor 3 is transmitted to the inner disk support 7 by means of the gear train 4, 5 and the thrust collar 6. Since the inner disk support 7 is affixed to the shaft 10, the rotation of the rotor can be transmitted to the motor 12 by means of the clutch-bypassing clutch 15, and the motor 12 can be started.

In both of the variants described above, the stationary vehicle 13 is disconnected because of the disengaged clutch.

In the two possible variants described above, a generator function can also be produced when the vehicle is stationary; the stationary vehicle 13 is disconnected because of the disengaged clutch 14. Since the actuator 1 in variant A of the third exemplary embodiment is disposed on the side of the clutch that is connected to the stationary vehicle 13, the generator function can only be produced by engaging the clutch-bypassing clutch 15 so that the rotor 3 is driven by means of the bypass clutch 15. In variant B of the third exemplary embodiment, the motor 12 drives the rotor of the actuator 1 by means of the clutch 7, 8, which is locked together when it is engaged. In this instance, the bypass clutch 15 is disengaged.

In variant B of the third exemplary embodiment, the generator function while the vehicle is driving is assured in that when the clutch 7, 8 is engaged, the motor 12 also drives the rotor 3. In variant A of the third exemplary embodiment, the generator function while the vehicle is driving is achieved in that when the clutch 7, 8 is disengaged, the vehicle 13 drives the rotor by means of the engaged clutch 14. As a result, in this instance, the generator function during driving can only be achieved in connection with a double-clutch gear train, in the respective load branch that is not under load.

If the planet gear is embodied according to variant A of the third exemplary embodiment so that when the actuator 1 is used a motor, the clutch 7, 8 engages, then it is also possible to achieve a braking energy recovery since, during braking or during a deceleration of the vehicle, the actuator 1 functions as a generator and thus brakes the vehicle even more.

By contrast, if the planet gear 5 is embodied according to variant B of the third exemplary embodiment so that when the actuator 1 is used a motor, the clutch 7, 8 disengages, then the function of “gear train synchronization” can also be achieved.

In all of the exemplary embodiments described above, it should be noted that these are preferably used in a double-clutch gear train, where one branch of the gear train is always load-free and the other is load-bearing. Consequently, all necessary functions of the actuator, i.e. its function as a clutch actuator, a starter, and a generator, can be produced both when the vehicle is driving and when it is stationary; in particular, the generator function during driving is produced by means of the branch that is not under load.

Consequently, the invention discloses an actuator, which can be used as a clutch actuator/starter, as a clutch actuator/generator, or as a clutch actuator/starter/generator. Consequently, an actuator that is embodied as an auxiliary unit can perform several functions for the motor, thus permitting the number of parts, the amount of space required, and the weight of the motor to be reduced.

The foregoing description of exemplary embodiments of the current invention is solely intended for illustrative purposes and is not intended to limit the scope of the invention. Numerous different changes and modifications are possible without going beyond the scope of the invention and its equivalents.

1. An actuator for actuating a clutch (7, 8), which brings the clutch (7, 8) into and out of engagement by means of a gear train (4, 5), characterized in that the actuator (1) can simultaneously also be used as a starter for a motor (12).

2. The actuator according to claim 1, characterized in that the actuator (1) can also be used as a generator.

3. An actuator for actuating a clutch (7, 8), which brings the clutch (7, 8) into and out of engagement by means of a gear train (4, 5), characterized in that the actuator (1) can simultaneously also be used as a generator.

4. The actuator according to one of claims 1 to 3, characterized in that a bypass clutch (15) is provided in order to bypass the clutch (7, 8).

5. The actuator according to one of claims 1 to 4, characterized in that the gear train has a gear (5) with a helical gearing, which when driven by the actuator (1), brings the clutch (7, 8) into or out of engagement.

6. The actuator according to one of claims 1 to 5, characterized in that the actuator (1) permits a recovery of braking energy and/or a synchronization of the controllable clutches during gear changes.

7. The actuator according to one of claims 1 to 6, characterized in that when being used as a starter, the actuator brings the motor (12) into engagement with an outer disk support (8) by means of a gear train (4, 5) and an inner disk support (7), wherein the outer disk support (8) is connected to the motor (12) by means of a hollow shaft (9) and a transmission (11), thus permitting the motor (12) to be started.

8. The actuator according to one of claims 1 to 7, characterized in that when being used as a starter, the actuator can start the motor (12) by means of a gear train (4, 5), an inner disk support (7), and a shaft (10) that is connected to the motor (12).

9. The actuator according to one of claims 1 to 8, characterized in that the gear train (4, 5) is locked together by means of a thrust collar (6) when the disk clutch is disengaged.

10. A use of an actuator according to one of the preceding claims in a double-clutch gear train.
